(19) United States
(12) Patent Application Publication
(10) Pub. No.: US 2023/0075033 A1
(43) Pub. Date: Mar. 9, 2023

(54) RIDE-HAILING METHOD AND APPARATUS, ELECTRONIC DEVICE AND READABLE STORAGE MEDIUM

(71) Applicant: BEIJING BAIDU NETCOM SCIENCE TECHNOLOGY CO., LTD., Beijing (CN)

(72) Inventors: Hao Zhang, Beijing (CN); Xi Ma, Beijing (CN); Bu Mi, Beijing (CN); Xiufeng Han, Beijing (CN)

(73) Assignee: BEIJING BAIDU NETCOM SCIENCE TECHNOLOGY CO., LTD., Beijing (CN)

(21) Appl. No.: 17/656,636

(22) Filed: Mar. 25, 2022

(30) Foreign Application Priority Data
Sep. 9, 2021 (CN) 202111055468.7

(51) Int. Cl. G01C 21/34

(52) U.S. Cl. CPC G01C 21/3423; G01C 21/3476

(57) ABSTRACT

The present disclosure provides a ride-hailing method and apparatus, an electronic device and a readable storage medium, and relates to the field of artificial intelligence technologies such as intelligent transportation and deep learning. The ride-hailing method includes: acquiring a rapid ride-hailing request, the rapid ride-hailing request including a departure position and a destination position of a user; determining a target pick-up point according to the departure position and the destination position; obtaining an arrival time from the departure position to the target pick-up point; and outputting the target pick-up point and path planning information from the departure position to the target pick-up point when a target region where the target pick-up point is located is determined as an easy ride-hailing region according to the arrival time. According to the present disclosure, users' ride-hailing time can be reduced, and the users' ride-hailing efficiency can be improved.

The present application claims the priority of Chinese Patent Application No. 202111055468.7, filed on Sep. 9, 2021, with the title of “RIDE-HAILING METHOD AND APPARATUS, ELECTRONIC DEVICE AND READABLE STORAGE MEDIUM”. The disclosure of the above application is incorporated herein by reference in its entirety.

### FIELD OF THE DISCLOSURE

The present disclosure relates to the field of data processing technologies, and in particular, to the field of artificial intelligence technologies such as intelligent transportation and deep learning. A ride-hailing method and apparatus, an electronic device and a readable storage medium are provided.

### BACKGROUND OF THE DISCLOSURE

With the improvement of consumption levels, ride hailing has become an important transportation means for many users. In particular, with the development of online ride hailing and the further improvement of ride-hailing efficiency, more and more users will choose to travel by ride hailing.

Traveling by ride hailing has many unique advantages, such as shorter time, being easy to carry luggage and strong privacy. However, while the demand for ride hailing is increasing, a phenomenon of “difficult ride hailing” is brought. Even today, when online ride hailing is very mature, people often have to wait in line for hours to take a taxi at a time and in a region with strong demand.

### SUMMARY OF THE DISCLOSURE

According to a first aspect of the present disclosure, a method is provided, including: acquiring a rapid ride-hailing request, the rapid ride-hailing request including a departure position and a destination position of a user; determining a target pick-up point according to the departure position and the destination position; obtaining an arrival time from the departure position to the target pick-up point; and outputting the target pick-up point and path planning information from the departure position to the target pick-up point when a target region where the target pick-up point is located is determined as an easy ride-hailing region according to the arrival time.

According to a second aspect of the present disclosure, an electronic device is provided, including: at least one processor; and a memory communicatively connected with the at least one processor; wherein the memory stores instructions executable by the at least one processor, and the instructions are executed by the at least one processor to enable the at least one processor to perform a method, wherein the method includes: acquiring a rapid ride-hailing request, the rapid ride-hailing request including a departure position and a destination position of a user; determining a target pick-up point according to the departure position and the destination position; obtaining an arrival time from the departure position to the target pick-up point; and outputting the target pick-up point and path planning information from the departure position to the target pick-up point when a target region where the target pick-up point is located is determined as an easy ride-hailing region according to the arrival time.

According to a third aspect of the present disclosure, there is provided a non-transitory computer readable storage medium with computer instructions stored thereon, wherein the computer instructions are used for causing a computer to perform a method, wherein the method includes: acquiring a rapid ride-hailing request, the rapid ride-hailing request comprising a departure position and a destination position of a user; determining a target pick-up point according to the departure position and the destination position; obtaining an arrival time from the departure position to the target pick-up point; and outputting the target pick-up point and path planning information from the departure position to the target pick-up point when a target region where the target pick-up point is located is determined as an easy ride-hailing region according to the arrival time.

As can be seen from the above technical solutions, in this embodiment, when a user takes a taxi, the user can be moved from a “difficult ride-hailing” region to an “easy ride-hailing” region, thereby reducing the user's ride-hailing time and improving the user's ride-hailing efficiency.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure; and

FIG. 5 is a block diagram of an electronic device configured to perform a ride-hailing method according to an embodiment of the present disclosure.

### DETAILED DESCRIPTION OF PREFERRED EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

According to the ride-hailing method in this embodiment, after a rapid ride-hailing request is acquired, firstly, a target pick-up point is determined according to a departure position and a destination position, then an arrival time from the departure position to the target pick-up point is obtained, and finally, the target pick-up point and path planning information from the departure position to the target pick-up point are outputted when a target region where the target pick-up point is located is determined as an easy ride-hailing region according to the arrival time, so as to move a user from a “difficult ride-hailing” region to an “easy ride-hailing” region, thereby reducing the user's ride-hailing time and improving the user's ride-hailing efficiency.

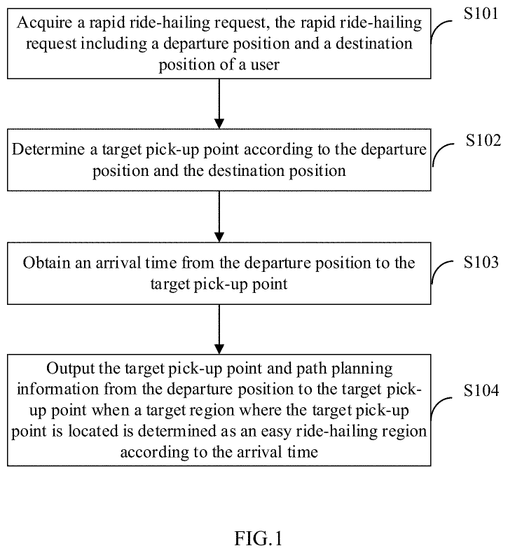

FIG. 1 is a schematic diagram according to a first embodiment of the present disclosure. As shown in FIG. 1, a ride-hailing method according to this embodiment may specifically include the following steps.

In S101, a rapid ride-hailing request is acquired, the rapid ride-hailing request including a departure position and a destination position of a user.

This embodiment may be performed by a server or a terminal device. If this embodiment is performed by a server, in this embodiment, the rapid ride-hailing request acquired by performing S101 is sent by a terminal device.

In this embodiment, the rapid ride-hailing request acquired by performing S101 may be generated according to a departure position and a destination position of a user after the terminal device detects a rapid ride-hailing function triggered by the user; or generated according to a departure position and a destination position of a user after the terminal device detects a current ride-hailing duration of the user exceeds a first preset duration.

In addition, in this embodiment, the rapid ride-hailing request acquired by performing S101 may further include the user's travel preferences for three transportation means: cycling and walking, a bus and a subway. For example, the user prefers at least one of cycling and walking, a bus and a subway.

In S102, a target pick-up point is determined according to the departure position and the destination position.

In this embodiment, after the rapid ride-hailing request acquired is acquired by performing S101, S102 is performed to determine a target pick-up point according to the departure position and the destination position included in the rapid ride-hailing request. In this embodiment, the determined target pick-up point and the departure position are located in different regions.

In this embodiment, the target pick-up point determined by performing S102 is one of a plurality of candidate pick-up points. The plurality of candidate pick-up points are pre-generated. Different candidate pick-up points correspond to different transportation means. The manner in which the candidate pick-up points are generated is described below.

Specifically, in this embodiment, when S102 is performed to determine a target pick-up point according to the departure position and the destination position, an optional implementation may involve: taking a region outside a region of the departure position as a target region; searching a preset road network for candidate pick-up points in the target region according to the departure position and the destination position, wherein the candidate pick-up points may be searched for by using a heuristic search algorithm such as an A* algorithm in this embodiment; and taking the found first candidate pick-up point as the target pick-up point. The determined target pick-up point corresponds to at least one of a target cycling and walking pick-up point, a target bus pick-up point and a target subway pick-up point.

That is, in this embodiment, after the target region is determined according to the departure position, the target pick-up point is determined according to the departure position, the destination position, the preset road network, and the candidate pick-up points in the target region, which prevents the determined target pick-up point being in a same region as the departure position and can improve the accuracy of the determined target pick-up point.

If, in this embodiment, the rapid ride-hailing request acquired by performing S101 further includes the user's travel preference, in this embodiment, when S102 is performed to take the found first candidate pick-up point as the target pick-up point, the following content may also be included: taking the found first candidate pick-up point meeting the acquired travel preference as the target pick-up point.

In this embodiment, the preset road network for search is a road system of an interwoven network of interconnecting roads in a certain region, and pre-generated candidate pick-up points are distributed over roads in the preset road network. The preset road network is at least one of a cycling and walking road network, a bus road network and a subway road network. The cycling and walking road network includes cycling and walking roads, the bus road network includes roads used by buses, and the subway road network includes roads used by subways.

Specifically, in this embodiment, when S102 is performed to search a preset road network for candidate pick-up points in the target region according to the departure position and the destination position, an optional implementation may involve: determining a transportation means, wherein the determined transportation means includes at least one of cycling and walking, a bus and a subway; and searching, by using a search method corresponding to the transportation means, the preset road network for the candidate pick-up points in the target region according to the departure position and the destination position.

That is, in this embodiment, the candidate pick-up points in the target region are found according to a search method corresponding to one or more transportation means, which can improve the accuracy of the found target pick-up point on the premise of fully meeting the user's transportation requirement.

In this embodiment, when S102 is performed to search, by using a search method corresponding to the transportation means, the preset road network for the candidate pick-up points in the target region according to the departure position and the destination position, an optional implementation may involve: taking a bus stop at a distance no more than a first preset distance from the departure position as a candidate bus stop when the transportation means is determined as a bus; and searching a bus road network for candidate bus pick-up points by taking the candidate bus stop as a starting point and the destination position as a target, and then taking the found first candidate bus pick-up point as the target pick-up point.

In this embodiment, when S102 is performed to search, by using a search method corresponding to the transportation means, the preset road network for the candidate pick-up points in the target region according to the departure position and the destination position, an optional implementation may involve: taking a subway stop at a distance no more than a second preset distance from the departure position as a candidate subway stop when the transportation means is determined as a subway; and searching a subway road network for candidate subway pick-up points by taking the candidate subway stop as a starting point and the destination position as a target, and then taking the found first candidate subway pick-up point as the target pick-up point.

In this embodiment, when S102 is performed to search, by using a search method corresponding to the transportation means, the preset road network for the candidate pick-up points in the target region according to the departure position and the destination position, an optional implementation may involve: searching a cycling and walking road network for candidate cycling and walking pick-up points in the target region by taking the departure position as a starting point and the destination position as a target when the transportation means is determined as cycling and walking, and then taking the found first candidate cycling and walking pick-up point as the target pick-up point.

In this embodiment, the target pick-up point determined by performing S102 and the departure position have a shortest distance from a region where the departure position is located to a region where the target pick-up point is located. That is, a path between the departure position and the target pick-up point is the shortest path from the departure position to the target region.

In S103, an arrival time from the departure position to the target pick-up point is obtained.

In this embodiment, after S102 is performed to determine the target pick-up point, S103 is performed to obtain an arrival time from the departure position to the target pick-up point.

Specifically, in this embodiment, when S103 is performed to obtain an arrival time from the departure position to the target pick-up point, an optional implementation may involve: determining a transportation means corresponding to the target pick-up point, wherein the determined transportation means is one of cycling and walking, a bus and a subway; obtaining the path planning information from the departure position to the target pick-up point according to a planning method corresponding to the transportation means, wherein the obtained path planning information includes a driving path from the destination position to the target pick-up point and path time of the driving path; and obtaining the arrival time according to a current time and the path planning information. That is, the arrival time is a sum of a current time and the path time.

If, in this embodiment, the target pick-up point determined by performing S102 is a target cycling and walking pick-up point, in this embodiment, S103 is performed to obtain the path planning information according to a planning method for traveling by cycling and walking. If, in this embodiment, the target pick-up point determined by performing S102 is a target bus pick-up point, in this embodiment, S103 is performed to obtain the path planning information according to a planning method for traveling by bus. If, in this embodiment, the target pick-up point determined by performing S102 is a target subway pick-up point, in this embodiment, S103 is performed to obtain the path planning information according to a planning method for traveling by subway.

In S104, the target pick-up point and path planning information from the departure position to the target pick-up point are outputted when a target region where the target pick-up point is located is determined as an easy ride-hailing region according to the arrival time.

In this embodiment, after S103 is performed to obtain the arrival time, S104 is performed to output the target pick-up point and path planning information from the departure position to the target pick-up point when a target region where the target pick-up point is located is determined as an easy ride-hailing region according to the arrival time.

Specifically, in this embodiment, when S104 is performed to determine a target region where the target pick-up point is located as an easy ride-hailing region according to the arrival time, an optional implementation may involve: acquiring a region feature of the target region where the target pick-up point is located, wherein the acquired region feature includes weather, a region ID, a number of points of interest in the region, attributes of points of interest in the region and the like; obtaining a ride-hailing duration of the target region according to the region feature and the arrival time; and determining the target region where the target pick-up point is located as the easy ride-hailing region when it is determined that the ride-hailing duration does not exceed a second preset duration.

In this embodiment, when S104 is performed, the ride-hailing duration may be predicted by using a pre-trained ride-hailing difficulty prediction model. The ride-hailing difficulty prediction model can output the ride-hailing duration corresponding to the target region according to the inputted arrival time and the region feature.

If, in this embodiment, it is determined that the target region where the target pick-up point is located is not an easy ride-hailing region when S104 is performed, S102 may be performed to continue searching for a target pick-up point, until a target region where the found target pick-up point is located is an easy ride-hailing region.

If, in this embodiment, only a target pick-up point and the path planning information to arrive at the target pick-up point are outputted by performing S104, S102 may also be performed to continue searching a target pick-up point, until the path planning information from the outputted departure position to the target pick-up point meets a preset condition. In this embodiment, the preset condition may be a distance difference between a driving path in newly found path planning information and a driving path in found path planning information exceeding a preset threshold.

In addition, in this embodiment, when S104 is performed to output the target pick-up point and path planning information from the departure position to the target pick-up point, the following content may also be included: acquiring an estimated arrival time from the target pick-up point to the destination position at the arrival time; and outputting the target pick-up point, the path planning information from the departure position to the target pick-up point and the estimated arrival time from the target pick-up point to the destination position.

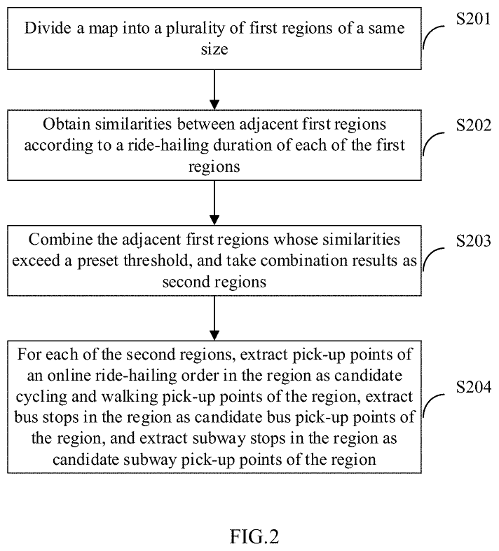

FIG. 2 is a schematic diagram according to a second embodiment of the present disclosure. As shown in FIG. 2, a method for generating candidate pick-up points according to this embodiment may specifically include the following steps.

In S201, a map is divided into a plurality of first regions of a same size.

In this embodiment, when S201 is performed, the map may be divided into a plurality of first regions according to a preset size. For example, each of the first regions is of a size of 500 m×500 m.

In S202, similarities between adjacent first regions are obtained according to a ride-hailing duration of each of the first regions.

In this embodiment, when S201 is performed, the ride-hailing duration of each of the first regions may be obtained by using a pre-trained ride-hailing difficulty prediction model. Different ride-hailing durations correspond to different ride-hailing difficulties. A same time and a region feature of each of the first regions are inputted to the ride-hailing difficulty prediction model, so as to obtain the ride-hailing duration outputted by the ride-hailing difficulty prediction model for each of the first regions.

In S203, the adjacent first regions whose similarities exceed a preset threshold are combined, and combination results are taken as second regions.

In this embodiment, S203 is performed to combine the adjacent first regions whose similarities exceed a preset threshold. That is, the first regions with similar ride-hailing difficulties are combined into a region. Therefore, in this embodiment, each of the second regions obtained by performing S203 has a different ride-hailing difficulty.

It may be understood that the target region in the above embodiment is a second region obtained by combining the first regions.

In S204, for each of the second regions, pick-up points of an online ride-hailing order in the region are extracted as candidate cycling and walking pick-up points of the region, bus stops in the region are extracted as candidate bus pick-up points of the region, and subway stops in the region are extracted as candidate subway pick-up points of the region.

In this embodiment, when S204 is performed to extract pick-up points of an online ride-hailing order in the region as candidate cycling and walking pick-up points of the region, first N popular pick-up points of the online ride-hailing order may be selected as the candidate cycling and walking pick-up points of the region, where N is a positive integer greater than or equal to 1.

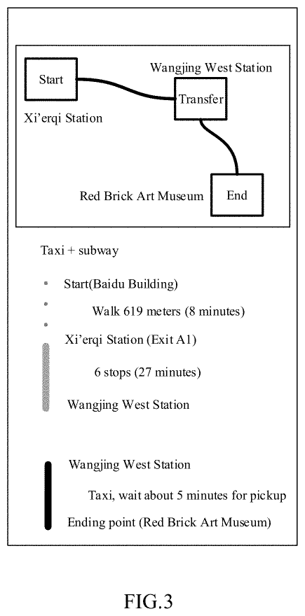

FIG. 3 is a schematic diagram according to a third embodiment of the present disclosure. FIG. 3 is a schematic diagram of a ride-hailing method according to this embodiment. If a region where a departure position “Baidu Building” of a user is located is a difficult ride-hailing region, in this embodiment, a subway station nearest to the departure position is “Xi'erqi Station”. If a determined target pick-up point is a subway station “Wangjing West Station”, path planning information from the departure position to the target pick-up point (BaiduBuilding-Xi'erqi Station-Wangjing West Station) is generated after a target region where “Wangjing West Station” is located is determined as an easy ride-hailing region. In this embodiment, information such as a driving path from the target pick-up point to a destination position “Red Brick Art Museum” and an estimated arrival time may be further outputted.

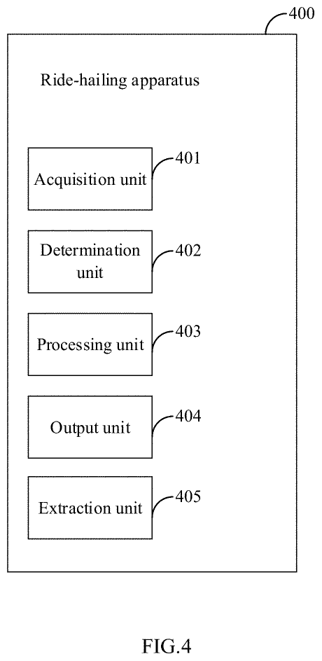

FIG. 4 is a schematic diagram according to a fourth embodiment of the present disclosure. As shown in FIG. 4, a ride-hailing apparatus 400 includes: an acquisition unit 401, a determination unit 402, a processing unit 403 and an output unit 404.

The acquisition unit 401 is configured to acquire a rapid ride-hailing request, the rapid ride-hailing request including a departure position and a destination position of a user.

The ride-hailing apparatus 400 in this embodiment may be located at a server or a terminal device. If the ride-hailing apparatus 400 is located at the server, the rapid ride-hailing request acquired by the acquisition unit 401 is sent by the terminal device.

The rapid ride-hailing request acquired by the acquisition unit 401 may be generated according to a departure position and a destination position of a user after the terminal device detects a rapid ride-hailing function triggered by the user; or generated according to a departure position and a destination position of a user after the terminal device detects a current ride-hailing duration of the user exceeds a first preset duration.

In addition, the rapid ride-hailing request acquired by the acquisition unit 401 may further include the user's travel preferences for three transportation means: cycling and walking, a bus and a subway. For example, the user prefers at least one of cycling and walking, a bus and a subway.

The determination unit 402 is configured to determine a target pick-up point according to the departure position and the destination position.

In this embodiment, after the acquisition unit 401 acquires the rapid ride-hailing request acquired, the determination unit 402 determines a target pick-up point according to the departure position and the destination position included in the rapid ride-hailing request. The target pick-up point determined by the determination unit 402 and the departure position are located in different regions.

The target pick-up point determined by the determination unit 402 is one of a plurality of candidate pick-up points. The plurality of candidate pick-up points are pre-generated. Different candidate pick-up points correspond to different transportation means. The candidate pick-up points are generated by an extraction unit 405.

Specifically, when the determination unit 402 determines a target pick-up point according to the departure position and the destination position, an optional implementation may involve: taking a region outside a region of the departure position as a target region; searching a preset road network for candidate pick-up points in the target region according to the departure position and the destination position; and taking the found first candidate pick-up point as the target pick-up point. The determined target pick-up point corresponds to at least one of a target cycling and walking pick-up point, a target bus pick-up point and a target subway pick-up point.

That is, after determining the target region according to the departure position, the determination unit 402 determines the target pick-up point according to the departure position, the destination position, the preset road network, and the candidate pick-up points in the target region, which prevents the determined target pick-up point being in a same region as the departure position and can improve the accuracy of the determined target pick-up point.

If the rapid ride-hailing request acquired by the acquisition unit 401 further includes the user's travel preference, when the determination unit 402 takes the found first candidate pick-up point as the target pick-up point, the following content may also be included: taking the found first candidate pick-up point meeting the acquired travel preference as the target pick-up point.

Specifically, when the determination unit 402 searches a preset road network for candidate pick-up points in the target region according to the departure position and the destination position, an optional implementation may involve: determining a transportation means, wherein the determined transportation means includes at least one of cycling and walking, a bus and a subway; and searching, by using a search method corresponding to the transportation means, the preset road network for the candidate pick-up points in the target region according to the departure position and the destination position.

That is, the determination unit 402 searches for the candidate pick-up points in the target region according to a search method corresponding to one or more transportation means, which can improve the accuracy of the found target pick-up point on the premise of fully meeting the user's transportation requirement.

When the determination unit 402 searches, by using a search method corresponding to the transportation means, the preset road network for the candidate pick-up points in the target region according to the departure position and the destination position, an optional implementation may involve: taking a bus stop at a distance no more than a first preset distance from the departure position as a candidate bus stop when the transportation means is determined as a bus; and searching a bus road network for candidate bus pick-up points by taking the candidate bus stop as a starting point and the destination position as a target, and then taking the found first candidate bus pick-up point as the target pick-up point.

When the determination unit 402 searches, by using a search method corresponding to the transportation means, the preset road network for the candidate pick-up points in the target region according to the departure position and the destination position, an optional implementation may involve: taking a subway stop at a distance no more than a second preset distance from the departure position as a candidate subway stop when the transportation means is determined as a subway; and searching a subway road network for candidate subway pick-up points by taking the candidate subway stop as a starting point and the destination position as a target, and then taking the found first candidate subway pick-up point as the target pick-up point.

When the determination unit 402 searches, by using a search method corresponding to the transportation means, the preset road network for the candidate pick-up points in the target region according to the departure position and the destination position, an optional implementation may involve: searching a cycling and walking road network for candidate cycling and walking pick-up points in the target region by taking the departure position as a starting point and the destination position as a target when the transportation means is determined as cycling and walking, and then taking the found first candidate cycling and walking pick-up point as the target pick-up point.

The target pick-up point determined by the determination unit 402 and the departure position have a shortest distance from a region where the departure position is located to a region where the target pick-up point is located. That is, a path between the departure position and the target pick-up point is the shortest path from the departure position to the target region.

The processing unit 403 is configured to obtain an arrival time from the departure position to the target pick-up point.

In this embodiment, after the determination unit 402 determines the target pick-up point, the processing unit 403 obtains an arrival time from the departure position to the target pick-up point.

Specifically, when the processing unit 403 obtains an arrival time from the departure position to the target pick-up point, an optional implementation may involve: determining a transportation means corresponding to the target pick-up point; obtaining the path planning information from the departure position to the target pick-up point according to a planning method corresponding to the transportation means; and obtaining the arrival time according to a current time and the path planning information. That is, the arrival time is a sum of a current time and the path time.

If the target pick-up point determined by the determination unit 402 is a target cycling and walking pick-up point, the processing unit 403 obtains the path planning information according to a planning method for traveling by cycling and walking. If the target pick-up point determined by the determination unit 402 is a target bus pick-up point, the processing unit 403 obtains the path planning information according to a planning method for traveling by bus. If the target pick-up point determined by the determination unit 402 is a target subway pick-up point, the processing unit 403 obtains the path planning information according to a planning method for traveling by subway.

The output unit 404 is configured to output the target pick-up point and path planning information from the departure position to the target pick-up point when a target region where the target pick-up point is located is determined as an easy ride-hailing region according to the arrival time.

In this embodiment, after the processing unit 403 obtains the arrival time, the output unit 404 outputs the target pick-up point and path planning information from the departure position to the target pick-up point when a target region where the target pick-up point is located is determined as an easy ride-hailing region according to the arrival time.

When the output unit 404 determines a target region where the target pick-up point is located as an easy ride-hailing region according to the arrival time, an optional implementation may involve: acquiring a region feature of the target region where the target pick-up point is located; obtaining a ride-hailing duration of the target region according to the region feature and the arrival time; and determining the target region where the target pick-up point is located as the easy ride-hailing region when it is determined that the ride-hailing duration does not exceed a second preset duration.

The output unit 404 may predict the ride-hailing duration by using a pre-trained ride-hailing difficulty prediction model. The ride-hailing difficulty prediction model can output the ride-hailing duration corresponding to the target region according to the inputted arrival time and the region feature.

If the output unit 404 determines that the target region where the target pick-up point is located is not an easy ride-hailing region the determination unit 402 may continue searching for a target pick-up point, until a target region where the found target pick-up point is located is an easy ride-hailing region.

If the output unit 404 outputs only a target pick-up point and the path planning information to arrive at the target pick-up point, the determination unit 402 may also continue searching a target pick-up point, until the path planning information from the outputted departure position to the target pick-up point meets a preset condition. In this embodiment, the preset condition of the output unit 404 may be a distance difference between a driving path in newly found path planning information and a driving path in found path planning information exceeding a preset threshold.

In addition, when the output unit 404 outputs the target pick-up point and path planning information from the departure position to the target pick-up point, the following content may also be included: acquiring an estimated arrival time from the target pick-up point to the destination position at the arrival time; and outputting the target pick-up point, the path planning information from the departure position to the target pick-up point and the estimated arrival time from the target pick-up point to the destination position.

The ride-hailing apparatus 400 in this embodiment further includes an extraction unit 405, configured to pre-generate the candidate pick-up points in the following manner: dividing a map into a plurality of first regions of a same size; obtaining similarities between adjacent first regions according to a ride-hailing duration of each of the first regions; combining the adjacent first regions whose similarities exceed a preset threshold, and taking combination results as second regions; and for each of the second regions, extracting pick-up points of an online ride-hailing order in the region as candidate cycling and walking pick-up points of the region, extracting bus stops in the region as candidate bus pick-up points of the region, and extracting subway stops in the region as candidate subway pick-up points of the region.

Acquisition, storage and application of users' personal information involved in the technical solutions of the present disclosure comply with relevant laws and regulations, and do not violate public order and moral.

According to embodiments of the present disclosure, the present disclosure further provides an electronic device, a readable storage medium and a computer program product.

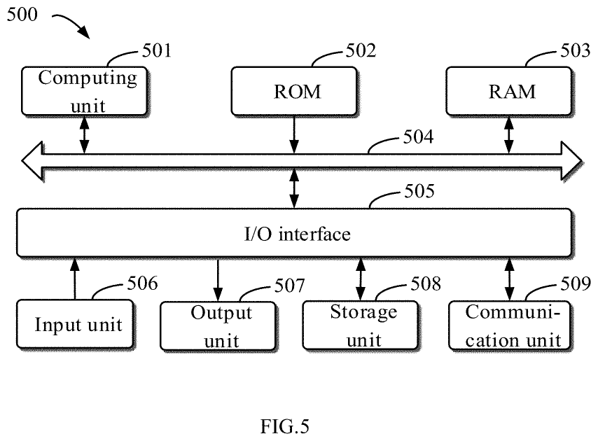

FIG. 5 is a block diagram of an electronic device configured to perform a ride-hailing method according to embodiments of the present disclosure. The electronic device is intended to represent various forms of digital computers, such as laptops, desktops, workbenches, personal digital assistants, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 5, the device 500 includes a computing unit 501, which may perform various suitable actions and processing according to a computer program stored in a read-only memory (ROM) 502 or a computer program loaded from a storage unit 508 into a random access memory (RAM) 503. The RAM 503 may also store various programs and data required to operate the device 500. The computing unit 501, the ROM 502 and the RAM 503 are connected to one another by a bus 504. An input/output (I/O) interface 505 may also be connected to the bus 504.

A plurality of components in the device 500 are connected to the I/O interface 505, including an input unit 506, such as a keyboard and a mouse; an output unit 507, such as various displays and speakers; a storage unit 508, such as disks and discs; and a communication unit 509, such as a network card, a modem and a wireless communication transceiver. The communication unit 509 allows the device 500 to exchange information/data with other devices over computer networks such as the Internet and/or various telecommunications networks.

The computing unit 501 may be a variety of general-purpose and/or special-purpose processing components with processing and computing capabilities. Some examples of the computing unit 501 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 501 performs the methods and processing described above, such as the ride-hailing method. For example, in some embodiments, the ride-hailing method may be implemented as a computer software program that is tangibly embodied in a machine-readable medium, such as the storage unit 508.

In some embodiments, part or all of a computer program may be loaded and/or installed on the device 500 via the ROM 502 and/or the communication unit 509. One or more steps of the ride-hailing method described above may be performed when the computer program is loaded into the RAM 503 and executed by the computing unit 501. Alternatively, in other embodiments, the computing unit 501 may be configured to perform the ride-hailing method by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable ride-hailing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, voice input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN) and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a Virtual Private Server (VPS). The server may also be a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the extent of protection of the present disclosure.

What is claimed is:

1. A method, comprising:
acquiring a rapid ride-hailing request, the rapid ride-hailing request comprising a departure position and a destination position of a user;
determining a target pick-up point according to the departure position and the destination position;
obtaining an arrival time from the departure position to the target pick-up point; and
outputting the target pick-up point and path planning information from the departure position to the target pick-up point when a target region where the target pick-up point is located is determined as an easy ride-hailing region according to the arrival time.

2. The method according to claim 1, wherein the step of determining a target pick-up point according to the departure position and the destination position comprises:
taking a region outside a region of the departure position as a target region;
searching a preset road network for candidate pick-up points in the target region according to the departure position and the destination position; and
taking the found first candidate pick-up point as the target pick-up point.

3. The method according to claim 2, wherein the step of searching a preset road network for candidate pick-up points in the target region according to the departure position and the destination position comprises:
determining a transportation means; and
searching, by using a search method corresponding to the transportation means, the preset road network for the candidate pick-up points in the target region according to the departure position and the destination position.

4. The method according to claim 3, wherein the step of searching, by using a search method corresponding to the transportation means, the preset road network for the candidate pick-up points in the target region according to the departure position and the destination position comprises:
taking a bus stop at a distance no more than a first preset distance from the departure position as a candidate bus stop when the transportation means is determined as a bus; and
searching a bus road network for candidate bus pick-up points by taking the candidate bus stop as a starting point and the destination position as a target.

5. The method according to claim 3, wherein the step of searching, by using a search method corresponding to the transportation means, the preset road network for the candidate pick-up points in the target region according to the departure position and the destination position comprises:
taking a subway stop at a distance no more than a second preset distance from the departure position as a candidate subway stop when the transportation means is determined as a subway; and
searching a subway road network for candidate subway pick-up points by taking the candidate subway stop as a starting point and the destination position as a target.

6. The method according to claim 3, wherein the step of searching, by using a search method corresponding to the transportation means, the preset road network for the candidate pick-up points in the target region according to the departure position and the destination position comprises:
searching a cycling and walking road network for candidate cycling and walking pick-up points in the target region by taking the departure position as a starting point and the destination position as a target when the transportation means is determined as cycling and walking.

7. The method according to claim 1, wherein the step of obtaining an arrival time from the departure position to the target pick-up point comprises:
determining a transportation means corresponding to the target pick-up point;
obtaining the path planning information from the departure position to the target pick-up point according to a planning method corresponding to the transportation means; and
obtaining the arrival time according to a current time and the path planning information.

8. The method according to claim 1, wherein the step of determining a target region where the target pick-up point is located as an easy ride-hailing region according to the arrival time comprises:
acquiring a region feature of the target region where the target pick-up point is located;
obtaining a ride-hailing duration of the target region according to the region feature and the arrival time; and
determining the target region where the target pick-up point is located as the easy ride-hailing region when it is determined that the ride-hailing duration does not exceed a second preset duration.

9. The method according to claim 1, further comprising:
dividing a map into a plurality of first regions of a same size;
obtaining similarities between adjacent first regions according to a ride-hailing duration of each of the first regions;
combining the adjacent first regions whose similarities exceed a preset threshold, and taking combination results as second regions; and
for each of the second regions, extracting pick-up points of an online ride-hailing order in the region as candidate cycling and walking pick-up points of the region, extracting bus stops in the region as candidate bus pick-up points of the region, and extracting subway stops in the region as candidate subway pick-up points of the region.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method, wherein the method comprises:
acquiring a rapid ride-hailing request, the rapid ride-hailing request comprising a departure position and a destination position of a user;
determining a target pick-up point according to the departure position and the destination position;
obtaining an arrival time from the departure position to the target pick-up point; and
outputting the target pick-up point and path planning information from the departure position to the target pick-up point when a target region where the target pick-up point is located is determined as an easy ride-hailing region according to the arrival time.

11. The electronic device according to claim 10, wherein the step of determining a target pick-up point according to the departure position and the destination position comprises:
taking a region outside a region of the departure position as a target region;
searching a preset road network for candidate pick-up points in the target region according to the departure position and the destination position; and
taking the found first candidate pick-up point as the target pick-up point.

12. The electronic device according to claim 11, wherein the step of searching a preset road network for candidate pick-up points in the target region according to the departure position and the destination position comprises:
determining a transportation means; and
searching, by using a search method corresponding to the transportation means, the preset road network for the candidate pick-up points in the target region according to the departure position and the destination position.

13. The electronic device according to claim 12, wherein the step of searching, by using a search method corresponding to the transportation means, the preset road network for the candidate pick-up points in the target region according to the departure position and the destination position comprises:
taking a bus stop at a distance no more than a first preset distance from the departure position as a candidate bus stop when the transportation means is determined as a bus; and
searching a bus road network for candidate bus pick-up points by taking the candidate bus stop as a starting point and the destination position as a target.

14. The electronic device according to claim 12, wherein the step of searching, by using a search method corresponding to the transportation means, the preset road network for the candidate pick-up points in the target region according to the departure position and the destination position comprises:
taking a subway stop at a distance no more than a second preset distance from the departure position as a candidate subway stop when the transportation means is determined as a subway; and
searching a subway road network for candidate subway pick-up points by taking the candidate subway stop as a starting point and the destination position as a target.

15. The electronic device according to claim 12, wherein the step of searching, by using a search method corresponding to the transportation means, the preset road network for the candidate pick-up points in the target region according to the departure position and the destination position comprises:
searching a cycling and walking road network for candidate cycling and walking pick-up points in the target region by taking the departure position as a starting point and the destination position as a target when the transportation means is determined as cycling and walking.

16. The electronic device according to claim 10, wherein the step of obtaining an arrival time from the departure position to the target pick-up point comprises:
determining a transportation means corresponding to the target pick-up point;
obtaining the path planning information from the departure position to the target pick-up point according to a planning method corresponding to the transportation means; and
obtaining the arrival time according to a current time and the path planning information.

17. The electronic device according to claim 10, wherein the step of determining a target region where the target pick-up point is located as an easy ride-hailing region according to the arrival time comprises:
acquiring a region feature of the target region where the target pick-up point is located;
obtaining a ride-hailing duration of the target region according to the region feature and the arrival time; and
determining the target region where the target pick-up point is located as the easy ride-hailing region when it is determined that the ride-hailing duration does not exceed a second preset duration.

18. The electronic device according to claim 10, further comprising:
dividing a map into a plurality of first regions of a same size;
obtaining similarities between adjacent first regions according to a ride-hailing duration of each of the first regions;
combining the adjacent first regions whose similarities exceed a preset threshold, and take combination results as second regions; and
for each of the second regions, extract pick-up points of an online ride-hailing order in the region as candidate cycling and walking pick-up points of the region, extracting bus stops in the region as candidate bus pick-up points of the region, and extracting subway stops in the region as candidate subway pick-up points of the region.

19. A non-transitory computer readable storage medium with computer instructions stored thereon, wherein the computer instructions are used for causing a computer to perform a method, wherein the method comprises:
acquiring a rapid ride-hailing request, the rapid ride-hailing request comprising a departure position and a destination position of a user;
determining a target pick-up point according to the departure position and the destination position;
obtaining an arrival time from the departure position to the target pick-up point; and
outputting the target pick-up point and path planning information from the departure position to the target pick-up point when a target region where the target pick-up point is located is determined as an easy ride-hailing region according to the arrival time.

20. The non-transitory computer readable storage medium according to claim 19, wherein the step of determining a target pick-up point according to the departure position and the destination position comprises:
taking a region outside a region of the departure position as a target region;
searching a preset road network for candidate pick-up points in the target region according to the departure position and the destination position; and
taking the found first candidate pick-up point as the target pick-up point.
